(19) United States
(12) Patent Application Publication
(10) Pub. No.: US 2025/0182962 A1
(43) Pub. Date: Jun. 5, 2025

(54) METHOD FOR MANUFACTURING LAMINATED INDUCTOR

(71) Applicant: Murata Manufacturing Co., Ltd., Kyoto-fu (JP)

(72) Inventor: Shohei YOSHIDA, Nagaokakyo-shi (JP)

(73) Assignee: Murata Manufacturing Co., Ltd., Kyoto-fu (JP)

(21) Appl. No.: 18/961,691

(22) Filed: Nov. 27, 2024

(30) Foreign Application Priority Data
Dec. 1, 2023 (JP) 2023-203817
Sep. 11, 2024 (JP) 2024-157512

(51) Int. Cl. H01F 41/061; H01F 27/28

(52) U.S. Cl. CPC H01F 41/061; H01F 27/2852

(57) ABSTRACT

A method for manufacturing a laminated inductor capable of reducing the number of laminated layers in manufacturing the laminated inductor. A method for manufacturing a laminated inductor includes preparing a plurality of first sheets A each including a conductor portion and a magnetic portion formed on a lower side of a magnetic sheet, and a first via portion penetrating the magnetic sheet on an upper side of the conductor portion; and laminating the plurality of first sheets A to form a first coil layer including a first coil to which the conductor portion is electrically connected with the first via portion interposed therebetween.

### CROSS-REFERENCE TO RELATED APPLICATIONS

This application claims benefit of priority to Japanese Patent Application No. 2024-157512, filed Sep. 11, 2024, and to Japanese Patent Application No. 2023-203817, filed Dec. 1, 2023, the entire content of each is incorporated herein by reference.

### BACKGROUND

### Technical Field

The present disclosure relates to a method for manufacturing a laminated inductor.

### Background Art

In recent years, DC-DC converters of voltage conversion circuits have been increasing in current and efficiency due to high functionality of devices, and rated current of power inductors used in these devices has also been increasing.

Japanese Patent Application Laid-Open No. 2019-176109, which shows an example of the inductor, discloses a passive component including: an insulating base part; an internal conductor that is built in the base part and includes a coil conductor and an extended conductor extended out from the coil conductor; and an external electrode electrically connected to the internal conductor. Japanese Patent Application Laid-Open No. 2019-176109 also discloses a method for manufacturing a laminated passive component in which green sheets are laminated.

### SUMMARY

In the conventional method for manufacturing a laminated passive component, each pattern layer (referring to a plurality of layers formed by laminating a plurality of the same patterns, or a single layer) is formed by printing and laminating a plurality of green sheets, and hence there is a problem that the number of laminated layers is relatively large and manufacturing cost is increased. For example, in the case of manufacturing a laminated inductor having a structure illustrated in the sectional view of FIG. 3 to be described later in the conventional manufacturing method, respective pattern layers n1 to n17 (particularly, pattern layers n3 to n17) are formed by laminating a plurality of layers, respectively, and hence the number of laminated layers is relatively large and manufacturing cost is increased.

Accordingly, the present disclosure provides, in manufacturing a laminated inductor, a method for manufacturing the laminated inductor capable of reducing the number of laminated layers.

The present disclosure relates to a method for manufacturing a laminated inductor, the method including preparing a plurality of first sheets A each having a conductor portion and a magnetic portion formed on a lower side of a magnetic sheet, and a first via portion penetrating the magnetic sheet on an upper side of the conductor portion; and laminating the plurality of first sheets A to form a first coil layer including a first coil to which the conductor portion is electrically connected with the first via portion interposed therebetween.

According to the present disclosure, the number of laminated layers can be reduced in manufacturing a laminated inductor. In detail, the method for manufacturing a laminated inductor of the present disclosure uses specific sheets, so that the number of laminated layers can be reduced compared to the conventional method for manufacturing a laminated inductor in which a large number of green sheets are laminated for each pattern layer.

### BRIEF DESCRIPTION OF THE DRAWINGS

FIG. 1 is a perspective view schematically illustrating an example of a laminated inductor manufactured by a manufacturing method according to the present disclosure;

FIG. 2 is an exploded perspective view for explaining a laminated structure of the laminated inductor in FIG. 1;

FIG. 3 is a sectional view schematically illustrating a section taken along line A-A in the laminated inductor in FIG. 1;

FIG. 4 is a flow diagram illustrating steps for explaining a method for manufacturing specific sheets (particularly, a first sheet A, a first sheet B, and a first sheet C) used in the method for manufacturing a laminated inductor of the present disclosure;

FIG. 5 is a flow diagram illustrating steps for explaining a method for manufacturing another specific sheet (particularly, a second sheet) used in the method for manufacturing a laminated inductor of the present disclosure; and

FIGS. 6A to 6D are sectional views for explaining in detail a specific sheet (particularly, each of the first sheet A, the first sheet B, the first sheet C, and the second sheet) used in the method for manufacturing a laminated inductor of the present disclosure, which are enlarged sectional views of the vicinity of a via part or a penetrating portion.

### DETAILED DESCRIPTION

Hereinafter, a method for manufacturing a laminated inductor according to the present disclosure will be described. Note that the laminated inductor manufactured by the manufacturing method of the present disclosure is not limited to the following configurations, and may be appropriately changed without departing from the gist of the present disclosure. The present disclosure also includes a combination of a plurality of preferred configurations described below.

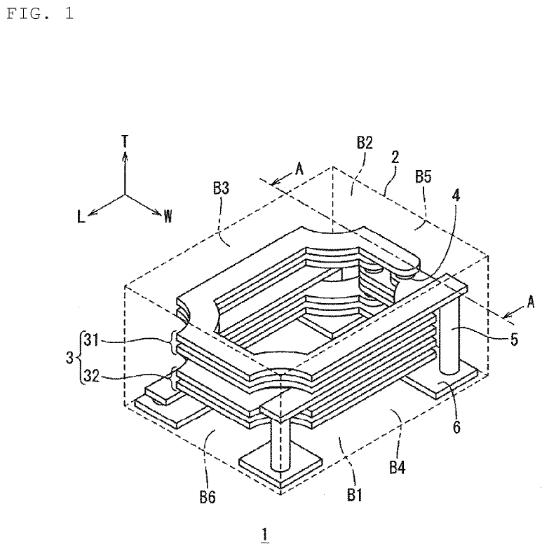

In the present specification, a term (e.g., “parallel”, “orthogonal”, “vertical”, or the like) indicating a relationship between elements and a term indicating a shape of an element not only mean only strictly literal aspects, but also mean substantially equivalent ranges, for example, ranges including a difference of about several %. In the present specification, a direction, in which sheets are laminated during manufacturing, is defined as a “lamination direction” (e.g., a direction T in FIG. 1).

The term “plan view” used in the present specification refers to a state (top view or bottom view) when an object is viewed from the upper side or the lower side along the thickness direction based on the lamination direction. In particular, a state, when an object is viewed from the lower side (or bottom side) along the thickness direction based on the lamination direction, may be referred to as “bottom view” (lower side view or bottom surface view). In addition, the “section view” refers to a sectional state (sectional view) when an object is viewed from a direction substantially perpendicular to a lamination direction T (e.g., a direction L or W in FIG. 1). The terms “up and down direction” and “left and right direction” used directly or indirectly in the present specification correspond to an up and down direction and a left and right direction in the drawings, respectively. Unless otherwise specified, the same reference signs or symbols shall denote the same members or sites or the same meanings. According to a preferred aspect, it can be understood that the downward direction in the vertical direction (i.e., the direction in which gravity acts) corresponds to a “downward direction”, whereas the opposite direction corresponds to an “upward direction”. In particular, in a method for manufacturing a bottom electrode type laminated inductor including an electrode on a bottom surface, “lower side” and “upper side” respectively refer to “lower side” and “upper side” in a sectional view or an exploded view of the laminated inductor when the laminated inductor is left stationary with the bottom surface, on which the electrode is provided, on the lower side and an upper surface opposite to the bottom surface on the upper side.

The drawings shown below are schematic views, and dimensions, scales of aspect ratios, and the like may be different from those of an actual product.

An embodiment of an example of the method for manufacturing a laminated inductor according to the present disclosure will be described with reference to FIGS. 1 to 6D. Note that the shapes, arrangements, and the like of the laminated inductor and each component are not limited to the illustrated examples.

FIG. 1 is a perspective oblique view schematically illustrating a laminated inductor manufactured by a manufacturing method according to the present disclosure. As illustrated in FIG. 1, a laminated inductor 1 usually includes, inside a base body (magnetic material) 2 containing iron powder, a coil 3 around which a coil conductor is wound, a via part 4 electrically connecting the coil conductors (conductor portions) of the coils 3 to each other, a penetrating portion 5 electrically connected to the coil conductor (conductor portion) of the coil 3 and extending in a bottom surface direction of the base body, and an external electrode part 6 disposed on a bottom surface side of the base body and electrically connected to the penetrating portion 5. The “via part” refers to a via hole part filled with a conductive material, and is a member that can be simply referred to as a “via hole part” or a “via conductor portion”. The “penetrating portion” refers to a through hole part filled with a conductive material, and is a member that can be simply referred to as a “through hole part” or a “through-conductor portion”.

The coil 3 includes two coils (i.e., a first coil and a second coil denoted by reference signs 31 and 32, respectively) in FIG. 1, but is not limited thereto, and the number of the coils may be one or three or more. The number of windings of each of the first coil and the second coil is 2.5, but is not particularly limited. In the present specification, the “via part” is used as a concept of a coupling path for electrically connecting the coils to each other, and the “penetrating portion” is used as a concept of a coupling path for electrically connecting the coil to the external electrode part. Therefore, if a member is referred to as a “penetrating portion”, the member may be referred to as a “via part” when the member has a function of electrically connecting coils to each other by its arrangement. On the other hand, if a member is referred to as a “via part”, the member may be referred to as a “penetrating portion” when the member has a function of electrically connecting a coil to an external electrode part by its arrangement.

The base body 2 has, for example, a rectangular parallelepiped shape or a substantially rectangular parallelepiped shape having six surfaces. The base body 2 may have vertices and edges rounded. The vertex is a portion where three surfaces of the base body 2 intersect, and the edge is a portion where two surfaces of the base body 2 intersect.

In FIG. 1, the length direction, the width direction, and the height direction of the laminated inductor 1 and the base body 2 are indicated as an L direction, a W direction, and a T direction, respectively. The length direction L, the width direction W, and the height direction T are orthogonal to each other. The mounting surface of the laminated inductor 1 is, for example, a surface (LW surface) parallel to the length direction L and the width direction W.

The base body 2 illustrated in FIG. 1 includes a first main surface B1 and a second main surface B2 facing each other in the height direction T, a first end surface B5 and a second end surface B6 facing each other in the length direction L orthogonal to the height direction T, and a first side surface B3 and a second side surface B4 facing each other in the width direction W orthogonal to the length direction L and the height direction T. In the example illustrated in FIG. 1, the first main surface B1 of the base body 2 corresponds to the mounting surface (bottom surface) of the base body 2.

The base body 2 includes, inside the magnetic material, the coil 3 around which a coil conductor is wound, the via part 4 electrically connecting the coil conductors of the coils 3 to each other, the penetrating portion 5 electrically connected to the coil conductor of the coil 3 and extending in the bottom surface direction of the base body 2, and an external electrode part 50 disposed on the bottom surface side of the base body and electrically connected to the penetrating portion 5. A plurality of coils (e.g., the first coil 31 and the second coil 32) may be included in the magnetic material in the lamination direction (e.g., the height direction T).

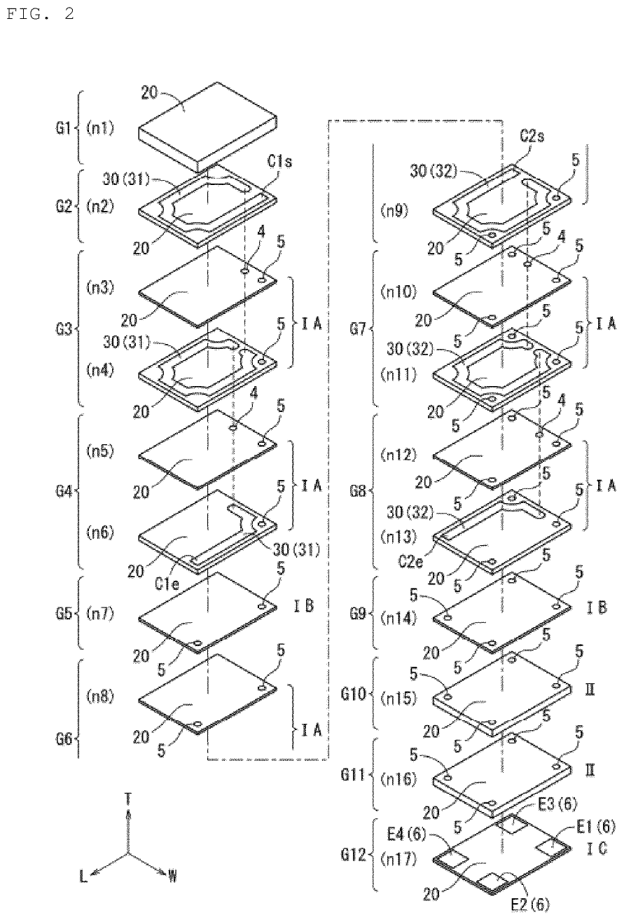

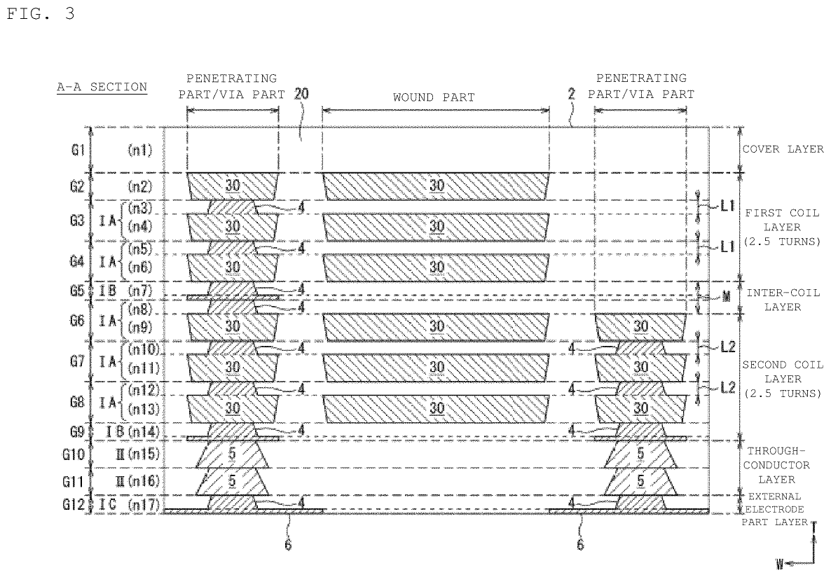

FIG. 2 is an exploded perspective view for explaining a laminated structure of the laminated inductor 1 in FIG. 1. FIG. 3 is a sectional view schematically illustrating a section taken along line A-A in the laminated inductor in FIG. 1. As illustrated in FIGS. 2 and 3, the laminated inductor 1 of the present disclosure includes pattern layers n1 to n17. In FIGS. 1 and 2, the penetrating portion 5 is drawn as having a simple columnar shape, but in each pattern layer of the actual section, the via part, the penetrating portion, and the external electrode part may have different shapes in plan view, as illustrated in FIG. 3. In FIG. 3, the white area inside the base body 2 indicates a magnetic portion 20 including a magnetic sheet 200, and the hatched area indicates the conductor portion such as the coil, the penetrating portion, or the via part, unless otherwise specified. Particularly in FIG. 3, conductor portions 30 disposed in laminated groups G3, G4, and G6 to G8 to be described later, and the via parts 4 disposed immediately above the conductor portions may correspond to the penetrating portions 5 of the laminated groups in FIG. 2.

In the present disclosure, the laminated inductor 1 is manufactured by laminating a laminated group G1 to a laminated group G12.

In the method for manufacturing a laminated inductor according to the present disclosure, lamination is performed using a non-penetrating sheet (hereinafter, the sheet may be referred to as a “first sheet”), and lamination is preferably performed using the first sheet and a penetrating sheet (hereinafter, it may be referred to as a “second sheet”) from the viewpoint of further reducing the number of laminated layers.

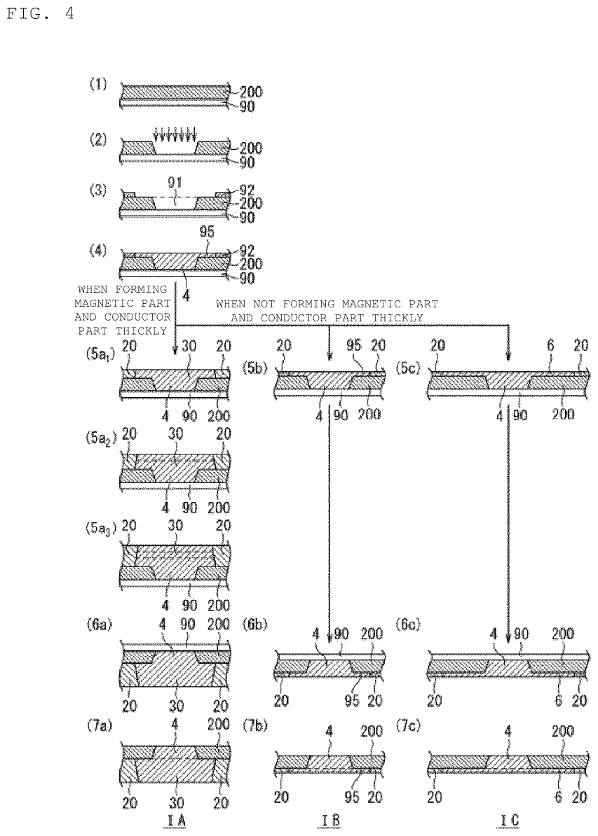

FIG. 4 is a flow diagram illustrating steps for explaining a method for manufacturing a first sheet (including a first sheet A, a first sheet B, and a first sheet C) used in the method for manufacturing a laminated inductor of the present disclosure. The first sheet is a non-penetrating sheet manufactured without penetrating a substrate during manufacturing, and includes the first sheet A denoted by a reference sign “IA” in a step (7a) in FIG. 4, the first sheet B denoted by a reference sign “IB” in a step (7b), and the first sheet C denoted by a reference sign “IC” in a step (7c) according to the thickness of the magnetic portion 20 and the presence or absence of a remaining pad part 95 to be described later.

### (First Sheet A)

The first sheet A is represented by the reference sign “IA” in, for example, FIGS. 2, 3, 4, and 6A to 6D, and includes the linear conductor portion 30 and the magnetic portion 20 formed on the lower side of the magnetic sheet 200, and the via part 4 penetrating the magnetic sheet 200 on the upper side of the conductor portion 30 (the via part included in the first sheet A may be referred to as a first via portion). The via part 4 is usually disposed on the upper side of the end part of the linear conductor portion 30 continuously formed in plan view. In one surface (particularly, the upper surface) of the first sheet A, the surface (exposed surface) of the via part 4 is usually flush with the surface (exposed surface) of the magnetic sheet 200. In the other surface (particularly, the lower surface) of the first sheet A, the surface (exposed surface) of the conductor portion 30 is usually flush with the surface (exposed surface) of the magnetic portion 20. In the present specification, being flush refers to a state in which there is no step between the two adjacent surfaces. In the present disclosure, the first sheet A, corresponding to two sheets in the conventional method, is used, so that the number of laminated layers during manufacturing can be reduced. In addition, the magnetic sheet 200 is formed as a thinner magnetic layer as described later, the first sheet A can be manufactured without penetrating the substrate. Therefore, in the first sheet A, the thickness of the base body (particularly, each pattern layer constituting the base body) can be easily adjusted. Furthermore, the first sheet A can be manufactured by using only one substrate for one sheet as shown in the manufacturing method to be described later, so that the first sheet A is excellent in manufacturing cost. Furthermore, by using the first sheet A, the via part can be formed more thinly and the conductor portion can be formed more thickly with a limited base body size, so that the characteristics of the inductor can be improved. Note that the via part 4 included in the first sheet A may be the penetrating portion or may be both the via part and the penetrating portion, according to the arrangement of the first sheet A. For example, in the first sheet A illustrated in FIG. 3, the conductor portion 30 and the via part 4 disposed immediately above the conductor portion may be integrally referred to as a via part or a penetrating portion. In the case of being referred to as a penetrating portion, the conductor portion 30 may have, in plan view, a non-linear shape (e.g., an island shape), or a circular shape or a polygonal shape (e.g., a quadrangular shape or the like).

As illustrated in FIG. 4, the first sheet A is manufactured by the following method.

First, the magnetic sheet 200 is formed as the magnetic layer on a substrate 90 using a sheet forming method such as a doctor blade method (step (1)). A thickness K1 of the magnetic sheet is not particularly limited, and for example, may be 10 μm or more and 100 μm or less (i.e., from 10 μm to 100 μm), and particularly 10 μm or more and 20 μm or less (i.e., from 10 μm to 20 μm). The method for forming the magnetic layer is not particularly limited, and the magnetic layer may be formed by, for example, printing by a printing method, such as a coating printing method or a sheet printing method, and then drying.

In the printing method, a magnetic paste is used. As an example of a method for preparing the magnetic paste, iron powder having a volume-based cumulative 50% particle size, D50, of 2 μm or more and 20 μm or less (i.e., from 2 μm to 20 μm) is prepared. The “iron powder” is not limited to being strictly powdery, and includes those in which powdery materials are bonded to each other by heat treatment (firing) to be described later. The iron powder may contain Fe and/or Si. More specifically, it may be Fe particles or Fe alloy particles. The Fe alloy may be a Fe—Si-based alloy, a Fe—Si—Cr-based alloy, a Fe—Si—Al-based alloy, a Fe—Si—B—P—Cu—C-based alloy, and/or a Fe—Si—B—Nb—Cu-based alloy or the like. In addition, the iron powder may contain impurities, such as Cr, Mn, Cu, Ni, P, S, and/or Co, which are unintentional impurities in manufacturing. Since the iron powder is contained in the magnetic paste, the iron powder may contain an element (e.g., Cr, Al, Li, Zn) that is more easily oxidized than Fe added during the preparation of the magnetic paste. The magnetic paste is prepared by adding, to iron powder, cellulose or polyvinyl butyral (PVB) as a binder, a mixture of terpineol and butyl diglycol acetate (BCA) as a solvent, and the like and kneading them. When an Fe—Si alloy is used as the iron powder, the content of Si is preferably 2.0 at % or more and 8.0 at % or less (i.e., from 2.0 at % to 8.0 at %). When an Fe—Si—Cr alloy is used as the iron powder, the content of Si is preferably 2.0 at % or more and 8.0 at % or less (i.e., from 2.0 at % to 8.0 at %). When an Fe—Si—Cr alloy is used as the iron powder, the content of Cr is preferably 0.2 at % or more and 6.0 at % or less (i.e., from 0.2 at % to 6.0 at %). An insulating film may be provided on the surface of the iron powder. The insulating film is a film containing preferably a metal oxide, and more preferably a Si oxide. As the method for forming the insulating film, a sol-gel method is preferred. As an example of forming the insulating film by a sol-gel method, a sol-gel coating agent containing a Si alkoxide and an organic chain-containing silane coupling agent are mixed to form a mixed liquid. The mixed liquid is attached to the surface of the metal magnetic powder, and then subjected to heat treatment, thereby dehydrating the mixed liquid and allowing it to be bonded. Thereafter, by drying it at a predetermined temperature, the insulating film can be formed.

The material of the substrate 90 is not particularly limited, and may include, for example, a polymer such as polyester (e.g., polyethylene terephthalate). The thickness of the substrate 90 is not particularly limited as long as the magnetic sheet (magnetic layer) 200 can be transported and peeled off from the magnetic layer.

Next, a portion, corresponding to the via part to be described later in the magnetic sheet 200, is selectively removed from the magnetic sheet side by laser irradiation (step (2)). At this time, the substrate 90 is not penetrated. Since laser is used to form the via part as described above, the via part has a tapered shape in section view. Furthermore, in order to form the conductor portion and the magnetic portion after reverse in the subsequent step, the via part has a tapered shape with a small upper side in section view. The “tapered shape with a small upper side” refers to a shape in which the width, on the upper side, of the tapered shape is smaller than the width on the lower side in section view. For example, when having a circular shape in plan view, the via part has a truncated cone shape as a whole (particularly, a truncated cone shape in which the area of the upper surface is smaller than the area of the bottom surface).

After the selective removal, a positive metal mask 92 is used (step (3)), and a conductive paste is printed by a screen printing method to form the via part in a removed portion 91 (step (4)).

A conductor paste is used in a screen printing method for forming the via part. The conductor paste is prepared by allowing a binder and a solvent to be contained in a conductive material and kneading them.

As the conductive material, any conductive material, used as a material capable of forming a coil, a via part, and/or a penetrating portion in the field of laminated inductors, can be used, and for example, Ag, Au, Cu, Ni, Pd, Sn, an alloy of two or more thereof, or the like can be used. The binder and the solvent contained in the conductor paste are not particularly limited, and may be selected, for example, from ranges similar to those of the binder and the solvent contained in the magnetic paste, respectively. Considering misalignment of the metal mask and the like in the step (3) described above, it is difficult to form the via part 4 strictly only in the area of the removed portion 91. Therefore, in the step (4), a metal mask, having an opening larger than the via part 4 in plan view, is usually used. Therefore, the pad part 95 having a flange shape is formed around the via part 4. The “flange shape” is a shape extending outward around the via part, and is a shape characterized in section view and plan view (particularly, section view). The “flange shape” is, for example, a shape in which the pad part 95 extends in the direction perpendicular to the lamination direction T more than the via part 4 in section view. In addition, the “flange shape” is, for example, a shape in which the pad part 95 is disposed around the via part 4 in plan view. Note that, in plan view, the pad part 95 does not have to be strictly, continuously disposed all around the via part 4, and may be formed intermittently (or sporadically) in the peripheral direction of the via part.

After the via part is formed, the conductor portion 30 is formed on the via part 4 using the positive metal mask 92 (not illustrated), and the magnetic portion 20 is formed in an area other than the conductor portion 30 on the surface of the magnetic sheet 200 using a negative metal mask having the reverse pattern of the positive metal mask (step (5a₁)). By repeating the formation of the conductor portion and the magnetic portion by screen printing an appropriate number of times, the conductor portion and the magnetic portion can be thickened (steps (5a₂) and (5a₃)). In the method for manufacturing the first sheet A, the conductor portion 30 is formed on the via part 4, and hence the pad part 95 formed in the step (4) becomes a part of the conductor portion 30. The conductive paste for forming the conductor portion used in the present step may be selected from a range similar to that of the conductor paste for forming the via part used in the step (4). The magnetic paste for forming the magnetic portion used in the present step may be selected from a range similar to that of the magnetic paste used in the step (1).

After the formation of the conductor portion and the magnetic portion, they are reversed (step (6a)) and the substrate 90 is peeled off, thereby enabling the first sheet A to be obtained.

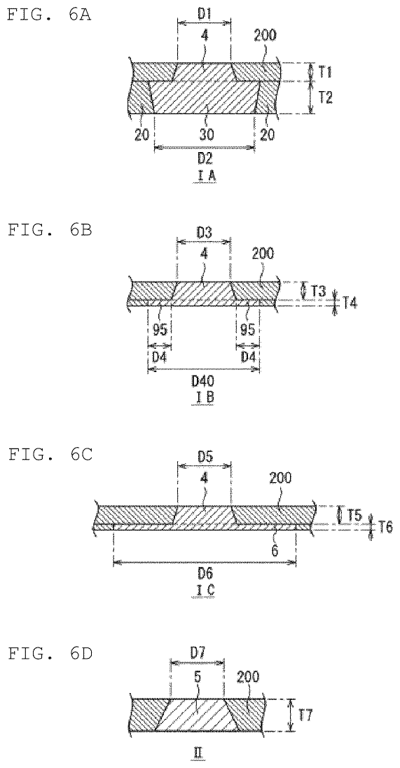

In the first sheet A, a diameter D1 of the via part 4 (first via portion) can be made smaller than a width D2 of the conductor portion 30 (see FIG. 6A). While effective in miniaturizing the laminated inductor, reduction in the diameter of the via part deteriorates electrical characteristics and decreases connection reliability after laminated. On the other hand, based on the fact that the first sheet A is effective in reducing the number of laminated layers, the reliability of electrical connection after laminated can be enhanced, and thus the diameter D1 of the via part 4 can be easily made smaller than the width D2 of the conductor portion 30.

The diameter D1 of the via part 4 refers to an average value of the minimum diameters of the respective via parts for arbitrary 10 via parts in section view parallel to the width direction or the length direction of the base body and passing through the centers of the via parts. The diameter D1 is not particularly limited, and for example, may be 50 μm or more and 200 μm or less (i.e., from 50 μm to 200 μm), and particularly 100 μm or more and 150 μm or less. Note that the diameter may also refer to a width when the member does not have a circular shape in plan view.

The width D2 of the conductor portion 30 refers to an average value of the minimum widths of the respective conductor portions for arbitrary 10 conductor portions 30 in section view parallel to the width direction or the length direction of the base body and passing through the centers of the conductor portions. The width D2 is not particularly limited, and for example, may be 100 μm or more and 330 μm or less (i.e., from 100 μm to 330 μm), and particularly 130 μm or more and 180 μm or less (i.e., from 130 μm to 180 μm).

In the first sheet A, a thickness T1 of the via part 4 (first via portion) is smaller than a thickness T2 of the conductor portion 30 (see FIG. 6A). As a result, the magnetic sheet 200 can be formed as a thinner magnetic layer, so that the first sheet A is further useful for adjusting the thickness of the base body (particularly, each pattern layer constituting the base body).

In the first sheet A, the thickness T1 of the via part 4 refers to an average value of the minimum thicknesses of the respective via parts for arbitrary 10 via parts in section view. The thickness T1 is not particularly limited, and may be a value within a range similar to that of the thickness K1 of the magnetic sheet in the first sheet A described above.

In the first sheet A, the thickness T2 of the conductor portion 30 refers to an average value of the minimum thicknesses of the respective conductor portions for arbitrary 10 conductor portions 30 in section view. The thickness T2 is not particularly limited, and for example, may be 20 μm or more and 120 μm or less (i.e., from 20 μm to 120 μm), and particularly 40 μm or more and 90 μm or less (i.e., from 40 μm to 90 μm).

### (First Sheet B)

The first sheet B is represented by a reference sign “IB” in, for example, FIGS. 2, 3, 4, and 6A to 6D; includes the via part 4 penetrating the magnetic sheet 200 (the via part included in the first sheet B may be referred to as a second via portion); and includes the magnetic portion 20 in an area other than the via part 4 on the lower surface of the magnetic sheet 200. The via part 4 included in the first sheet B may be the penetrating portion or may be both the via part and the penetrating portion according to the arrangement of the first sheet B. In detail, the first sheet B may include one or more via parts 4 or one or more penetrating portions, or may include one or more via parts 4 and one or more penetrating portions. In one surface (particularly, the upper surface) of the first sheet B, the surface (exposed surface) of the via part 4 is usually flush with the surface (exposed surface) of the magnetic sheet 200. In the other surface (particularly, the lower surface) of the first sheet B, the surface (exposed surface) of the via part 4 is usually flush with the surface (exposed surface) of the magnetic portion 20. In the present disclosure, the first sheet B is manufactured without penetrating the substrate as described later, so that the magnetic sheet 200 can be formed as a thinner magnetic layer. Therefore, the first sheet B is also useful for adjusting the thickness of the base body (particularly, each pattern layer constituting the base body), similarly to the first sheet A. Furthermore, the first sheet B can be manufactured by using only one substrate for one sheet as shown in a manufacturing method to be described later, so that the first sheet B is also excellent in manufacturing cost, similarly to the first sheet B.

As illustrated in FIG. 4, the first sheet B is manufactured by the following method.

Steps (1) to (4) are performed by the same method as the steps (1) to (4) in the method for manufacturing the first sheet A to form the via part 4 in the removed portion 91 of the magnetic sheet 200. In the method for manufacturing the first sheet B, laser is used to form the via part (particularly, the second via portion) as described above, and hence the via part has a tapered shape in section view. Furthermore, the via part is reversed in the subsequent step, and hence the via part has a “tapered shape with a small upper side” in section view. For example, when having a circular shape in plan view, the via part has a truncated cone shape as a whole (particularly, a truncated cone shape in which the area of the upper surface is smaller than the area of the bottom surface).

After the via part is formed, the magnetic portion 20 is formed in an area other than the via part 4 using a negative metal mask (step (5b)). The magnetic paste for forming the magnetic portion used in the present step may be selected from a range similar to that of the magnetic paste used in the step (1). In the method for manufacturing the first sheet B, the magnetic portion 20 is formed in an area other than the via part 4 without intentionally forming the conductor portion 30 on the via part 4 formed in the step (4), and hence the pad part 95 remains as the flange-shaped conductor portion. In detail, the pad part 95 is not intentionally formed, but is formed by itself around (e.g., in the outer peripheral part of) the via part 4 when the via part (particularly, the second via portion) 4 is formed, and includes a conductive material similar to that of the via part. For this reason, the pad part 95 may also be referred to as a “flange-shaped conductor portion”. Therefore, the first sheet B includes, on the lower side of the magnetic sheet 200, the flange-shaped conductor portion (i.e., the pad part 95) formed around (e.g., in the outer peripheral part of) the via part (particularly, the second via portion) 4, and the magnetic portion 20 formed further around the flange-shaped conductor portion, as described in the step (7b) to be described later. In more detail, the first sheet B described in the step (7b) to be described later includes, in bottom view, the second via portion 4, the flange-shaped conductor portion (i.e., the pad part 95) formed around (e.g., in the outer peripheral part of) the second via portion, and the magnetic portion 20 formed further around the flange-shaped conductor portion. In further detail, the magnetic portion 20 is particularly formed, in the first sheet B, in an area other than the via part (particularly, the second via portion) 4 and the flange-shaped conductor portion (i.e., the pad part 95) on the lower surface of the magnetic sheet 200.

After the formation of the conductor portion and the magnetic portion, they are reversed (step (6b)) and the substrate 90 is peeled off, thereby enabling the first sheet B to be obtained (step (7b)).

In the first sheet B, a diameter D3 of the via part 4 (second via portion) is usually smaller than a width D40 of the flange-shaped conductor portion (pad part 95) on the lower surface of the magnetic sheet 200 (see FIG. 6B). This is one of the characteristics of the first sheet B based on the fact that, in the first sheet B, the via part (particularly, the second via portion) 4 has a tapered shape with a small upper side in section view and the pad part 95 remains, as described above. The width D40 of the flange-shaped conductor portion (pad part 95) on the lower surface of the magnetic sheet 200 refers to the entire width (or maximum width) of the via part 4 (second via portion) including the flange-shaped conductor portion (pad part 95).

In the first sheet B, the diameter D3 (see FIG. 6B) of the via part 4 (second via portion) is not particularly limited, and for example, may be a value within a range similar to that of the diameter D1 of the via part 4 (first via portion) in the first sheet A. The diameter D3 of the via part 4 refers to an average value of the minimum diameters of the respective via parts for arbitrary 10 via parts in section view. Here, the diameter may also refer to a width when the member does not have a circular shape in plan view.

In the first sheet B, a thickness T3 (see FIG. 6B) of the via part 4 (second via portion) is not particularly limited, and for example, may be a value within a range similar to that of the thickness T1 of the via part 4 (first via portion) in the first sheet A. The thickness T3 of the via part 4 refers to an average value of the minimum thicknesses of the respective via parts for arbitrary 10 via parts in section view.

In the first sheet B, the width D4 (see FIG. 6B) of the pad part 95 may be usually 5 μm or more and 30 μm or less (i.e., from 5 μm to 30 μm), and particularly 10 μm or more and 15 μm or less (i.e., from 10 μm to 15 μm). The width D4 of the pad part 95 refers to an average value of the minimum widths of the respective pad parts for arbitrary 10 pad parts in section view.

In the first sheet B, the width D40 of the area of the via part 4 (second via portion) on the lower surface of the magnetic sheet 200 refers to an average value of the widths of the areas of arbitrary 10 via parts in section view parallel to the width direction or the length direction of the base body and passing through the centers of the via parts. The width D40 is not particularly limited, and for example, may be 60 μm or more and 250 μm or less (i.e., from 60 μm to 250 μm), and particularly 150 μm or more and 200 μm or less (i.e., from 150 μm to 200 μm).

In the first sheet B, the thickness T4 (see FIG. 6B) of the pad part 95 is not particularly limited, and for example, may be 1 μm or more and 50 μm or less (i.e., from 1 μm to 50 μm), and particularly 5 μm or more and 20 μm or less (i.e., from 5 μm to 20 μm), as an example.

### (First Sheet C)

The first sheet C is represented by a reference sign “IC” in, for example, FIGS. 2, 3, 4, and 6, and includes the external electrode part 6 having an island shape and the magnetic portion 20 formed on the lower side of the magnetic sheet 200, and the via part 4 penetrating the magnetic sheet 200 on the upper side of the external electrode part 6 (the via part included in the first sheet C may be referred to as a third via portion). In one surface (particularly, the upper surface) of the first sheet C, the surface (exposed surface) of the via part 4 is usually flush with the surface (exposed surface) of the magnetic sheet 200. In the other surface (particularly, the lower surface) of the first sheet C, the surface (exposed surface) of the external electrode part 6 is usually flush with the surface (exposed surface) of the magnetic portion 20. In the present disclosure, the first sheet C, corresponding to two sheets in the conventional method, is used, so that the number of laminated layers during manufacturing can be reduced as in the case of using the first sheet A. In addition, by using the first sheet C, the external electrode part can be formed thinly with a limited base body size, so that the characteristics of the inductor can be improved. Furthermore, the first sheet C can be manufactured by using only one substrate for one sheet as shown in a manufacturing method to be described later, so that the first sheet C is also excellent in manufacturing cost, similarly to the first sheet A.

As illustrated in FIG. 4, the first sheet C is manufactured by the following method.

Steps (1) to (4) are performed by the same method as the steps (1) to (4) in the method for manufacturing the first sheet A to form the via part 4 in the removed portion 91 of the magnetic sheet 200. In the method for manufacturing the first sheet C, laser is used to form the via part (particularly, the third via portion) as described above, and hence the via part has a tapered shape in section view. Furthermore, the via part is reversed in the subsequent step, and hence the via part has a “tapered shape with a small upper side” in section view. For example, when having a circular shape in plan view, the via part has a truncated cone shape as a whole (particularly, a truncated cone shape in which the area of the upper surface is smaller than the area of the bottom surface).

After the via part is formed, the external electrode part 6 is formed on the via part 4 using a positive metal mask 92 and a conductive paste, and the magnetic portion 20 is formed in an area other than the external electrode part 6 on the surface of the magnetic sheet 200 using a negative metal mask (not illustrated) having the reverse pattern of the positive metal mask (step (5c)). The magnetic paste for forming the magnetic portion used in the present step may be selected from a range similar to that of the magnetic paste used in the step (1). The conductive paste for forming the external electrode part used in the present step may be selected from a range similar to that of the conductor paste for forming the via part used in the step (4). In the method for manufacturing the first sheet C, the pad part 95 formed in the step (4) forms the external electrode part 6, and hence it is formed more widely than the pad part in the step (4) of the sheet step Ib.

After the formation of the conductor portion and the magnetic portion, they are reversed (step (6b)) and the substrate 90 is peeled off, thereby enabling the first sheet C to be obtained.

In the first sheet C, a diameter D5 (see FIG. 6C) of the via part 4 (third via portion) is not particularly limited, and for example, may be a value within a range similar to that of the diameter D1 of the via part 4 (first via portion) in the first sheet A. The diameter D5 of the via part 4 refers to an average value of the minimum diameters of the respective via parts for arbitrary 10 via parts in section view. Here, the diameter may also refer to a width when the member does not have a circular shape in plan view.

In the first sheet C, a thickness T5 (see FIG. 6C) of the via part 4 (third via portion) is not particularly limited, and for example, may be a value within a range similar to that of the thickness T1 of the via part 4 (first via portion) in the first sheet A. The thickness T5 of the via part 4 refers to an average value of the minimum thicknesses of the respective via parts for arbitrary 10 via parts in section view.

In the first sheet C, a width D6 (see FIG. 6C) of the external electrode part 6 may be usually 300 μm or more and 600 μm or less (i.e., from 300 μm to 600 μm), and particularly 450 μm or more and 500 μm or less (i.e., from 450 μm to 500 μm). The width D6 of the external electrode part 6 refers to an average value of the widths of arbitrary 10 external electrode parts in section view.

In the first sheet C, a thickness T6 (see FIG. 6C) of the external electrode part 6 may be usually 5 μm or more and 50 μm or less (i.e., from 5 μm to 50 μm), and particularly 15 μm or more and 25 μm or less (i.e., from 15 μm to 25 μm). The thickness T6 of the external electrode part 6 refers to an average value of the minimum thicknesses of the respective pad parts in arbitrary 10 external electrode parts in section view.

### (Second Sheet)

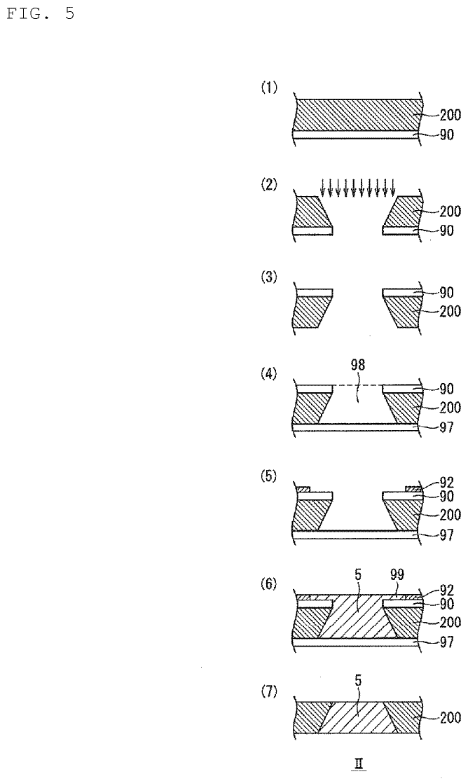

FIG. 5 is a flow diagram illustrating steps for explaining a method for manufacturing a second sheet used in the method for manufacturing a laminated inductor of the present disclosure. The second sheet is a penetrating sheet manufactured by penetrating the substrate during manufacturing, and is shown in a step (7) in FIG. 5. The second sheet is represented by a reference sign “II” in, for example, FIGS. 2, 3, 5, and 6A to 6D.

The second sheet is a magnetic sheet having the penetrating portion 5 penetrating the second sheet in the thickness direction. The penetrating portion 5 included in the second sheet may be the via part or both the via part and the penetrating portion according to the arrangement of the second sheet. In detail, the second sheet may include one or more via parts 4 or one or more penetrating portions, or may include one or more via parts 4 and one or more penetrating portions. Even in either one surface (particularly, the upper surface) or the other surface (particularly, the lower surface) of the second sheet, the surface (exposed surface) of the penetrating portion 5 is usually flush with the surface (exposed surface) of the magnetic sheet 200. In the present disclosure, the second sheet is manufactured by penetrating the substrate as described later, so that the magnetic sheet 200 can be formed as a thicker magnetic layer. Therefore, the second sheet is useful for forming the penetrating portion that is closer, in the lamination direction T, to the exterior side than a layer around which the coil conductor needs to be wound, and the number of laminated layers during manufacturing can be reduced.

As illustrated in FIG. 5, the second sheet is manufactured by the following method.

First, the magnetic sheet 200 is formed as a magnetic layer on the substrate 90 (step (1)). A thickness K2 of the magnetic sheet is not particularly limited, and for example, may be 20 μm or more and 100 μm or less (i.e., from 20 μm to 100 μm), and particularly 40 μm or more and 50 μm or less (i.e., from 40 μm to 50 μm). The method for forming the magnetic layer is not particularly limited, and the magnetic layer may be formed by the same method as the method for forming the magnetic layer for manufacturing the first sheet. The material of the substrate 90 is not particularly limited, and may be selected from a range similar to that of the material of the substrate for manufacturing the first sheet. The thickness of the substrate 90 is not particularly limited as long as the magnetic sheet (magnetic layer) 200 can be transported and peeled off from the magnetic layer, and for example, may be selected from a range similar to that of the thickness of the substrate for manufacturing the first sheet.

Next, a portion of the magnetic sheet 200, corresponding to the penetrating portion to be described later, is selectively removed from the magnetic sheet side by laser irradiation (step (2)). At this time, the substrate 90 is penetrated and opened. Since laser is used to form the penetrating portion as described above, the penetrating portion has a tapered shape in section view. Furthermore, the penetrating portion is reversed in the subsequent step, and hence the penetrating portion has a tapered shape with a small upper side in section view. For example, when having a circular shape in plan view, the penetrating portion has a truncated cone shape as a whole (particularly, a truncated cone shape in which the area of the upper surface is smaller than the area of the bottom surface).

After the selective removal, the penetrating portion is reversed (step (3)), and another substrate 97 is disposed on the laser irradiation side of the magnetic sheet 200 to seal the cavity by laser irradiation (step (4)). The material of the substrate 97 is not particularly limited, and may be selected from a range similar to that of the material of the substrate for manufacturing the first sheet. The thickness of the substrate 97 is not particularly limited as long as the magnetic sheet (magnetic layer) 200 can be transported and peeled off from the magnetic layer.

After the substrate 97 is disposed, the positive metal mask 92 is used to form the penetrating portion 5 in a removed portion 98 of the magnetic sheet 200 by a screen printing method (step (5), step (6)). A conductor paste is used in the screen printing method for forming the penetrating portion. The conductive paste for forming the penetrating portion used in the present step may be selected from a range similar to that of the conductor paste for forming the via part used in the step (4) during the manufacturing of the first sheet. In the step (5) described above during the manufacturing of the second sheet, it is difficult to strictly match the positive metal mask 92 only to the area other than the removed portion 98, and hence in the present step (6), a pad part 99 is usually formed around the penetrating portion 5 in plan view.

After the formation of the penetrating portion, the substrates 90 and 97 are peeled off, thereby enabling the second sheet to be obtained. In the method for manufacturing the second sheet, the substrate 90 is peeled off after the pad part 99 is manufactured, and hence the pad part 99 is removed along with the substrate.

In the second sheet, a thickness T7 (see FIG. 6D) of the penetrating portion 5 is larger than the thickness T1 of the via part 4 in the first sheet A. In detail, the thickness T7 (see FIG. 6D) of the penetrating portion 5 in each of the second sheets constituting the laminated inductor is larger than the thickness T1 of the via part 4 in any one of all the first sheets A constituting the laminated inductor. As a result, the second sheet is further useful for forming the penetrating portion, and is capable of further reducing the number of laminated layers during manufacturing, so that the reliability of electrical connection after laminated can be further enhanced.

The thickness T7 of the penetrating portion 5 refers to an average value of the minimum thicknesses of the respective penetrating portions for arbitrary 10 penetrating portions in section view. The thickness T7 is not particularly limited, and may be a value within a range similar to that of the thickness K2 of the magnetic sheet in the second sheet described above.

The thickness T1 of the via part 4 refers to the thickness T1 of the via part 4 described above.

A diameter D7 (see FIG. 6D) of the penetrating portion 5 is not particularly limited, and for example, may be 100 μm or more and 300 μm or less (i.e., from 100 μm to 300 μm), and particularly 120 μm or more and 180 μm or less (i.e., from 120 μm to 180 μm). The diameter D7 of the penetrating portion 5 refers to an average value of the minimum diameters of the respective penetrating portions for arbitrary 10 penetrating portions in section view. Here, the diameter may also refer to a width when the member does not have a circular shape in plan view.

### (Laminated Group)

The laminated inductor 1 may be formed by laminating the laminated group G1 to the laminated group G12 and firing them.

The laminated group G1 includes only the pattern layer n1, has the magnetic portion 20 as a magnetic layer, and constitutes the second main surface B2 of the base body 2. The magnetic layer as the laminated group G1 may be formed by any method, for example, may be formed by a printing method, or may be formed by laminating magnetic sheets. The magnetic sheet can be prepared, for example, by peeling the magnetic layer formed on the substrate by a printing method, such as a screen printing method, from the substrate.

The laminated group G2 includes only the pattern layer n2. The pattern layer n2 includes, in the magnetic portion 20 (or the magnetic sheet), the conductor portion 30 constituting the first coil (31). The conductor portion 30 of the laminated group G2 constitutes about one turn of the first coil. More specifically, the conductor portion 30 is disposed along the substantially outer periphery of the magnetic layer.

The laminated group G3 includes the pattern layers n3 and n4, these pattern layers being integrated in advance prior to lamination with other laminated groups. The pattern layer n3 includes, in the magnetic portion 20 (or magnetic sheet), the via part 4 for electrically connecting the conductor portion 30 of the pattern layer n2 and the conductor portion 30 of the pattern layer n4, and the penetrating portion 5 for electrically connecting the conductor portion 30 of the pattern layer n2 and the external electrode part 6 (E1) disposed on the bottom surface. The pattern layer n4 includes, in the magnetic portion 20 (or the magnetic sheet), the conductor portion 30 constituting the first coil (31) and the penetrating portion 5 for electrically connecting the conductor portion 30 of the pattern layer n2 and the external electrode part 6 (E1) disposed on the bottom surface. The laminated group G3 may include the first sheet A. The conductor portion 30 of the laminated group G3 (particularly, the pattern layer n4 constitutes about one turn of the first coil. More specifically, the conductor portion 30 is disposed, in the pattern layer n4, along the substantially outer periphery of the magnetic layer.

The laminated group G4 includes the pattern layers n5 and n6, these pattern layers being integrated in advance prior to lamination with other laminated groups. The pattern layer n5 is similar to the pattern layer n3 of the laminated group G3 except that the arrangements of the via parts 4 are different from each other. The pattern layer n6 is similar to the pattern layer n4 of the laminated group G3 except that the pattern shapes of the conductor portions 30 constituting the first coils (31) are different from each other. The laminated group G4 may include the first sheet A. The conductor portion 30 of the laminated group G4 (particularly, the pattern layer n6) constitutes about 0.5 turns of the first coil.

The laminated group G5 includes only the pattern layer n7. The pattern layer n7 includes, in the magnetic portion 20 (or magnetic sheet), the penetrating portion 5 for electrically connecting the conductor portion 30 of the pattern layer n2 and the external electrode part 6 (E1) disposed on the bottom surface, and the penetrating portion 5 for electrically connecting the conductor portion 30 of the pattern layer n6 and the external electrode part 6 (E2) disposed on the bottom surface. The laminated group G5 may include the first sheet B described above.

The laminated group G6 includes the pattern layers n8 and n9, these pattern layers being integrated in advance prior to lamination with other laminated groups. The pattern layer n8 is similar to the pattern layer n7 of the laminated group G5. The pattern layer n9 includes, in the magnetic portion 20 (or magnetic sheet), the conductor portion 30 constituting the second coil (32), the penetrating portion 5 for electrically connecting the conductor portion 30 of the pattern layer n2 and the external electrode part 6 (E1) disposed on the bottom surface, and the penetrating portion 5 for electrically connecting the conductor portion 30 of the pattern layer n6 and the external electrode part 6 (E2) disposed on the bottom surface. The laminated group G6 may include the first sheet A. The conductor portion 30 of the laminated group G6 (particularly, the pattern layer n9) constitutes about ¾ turns of the first coil.

The laminated group G7 includes the pattern layers n10 and n11, in which these pattern layers are integrated in advance prior to lamination with other laminated groups. The pattern layer n10 is similar to the pattern layer n8 of the laminated group G6 except that it further includes the via part 4 for electrically connecting the conductor portion 30 of the pattern layer n9 and the conductor portion 30 of the pattern layer n11, and the penetrating portion 5 for electrically connecting the conductor portion 30 of the pattern layer n9 and the external electrode part 6 (E3) disposed on the bottom surface. The pattern layer n11 includes, in the magnetic portion 20 (or magnetic sheet), the conductor portion 30 constituting the second coil (32), the penetrating portion 5 for electrically connecting the conductor portion 30 of the pattern layer n9 and the external electrode part 6 (E3) disposed on the bottom surface, the penetrating portion 5 for electrically connecting the conductor portion 30 of the pattern layer n2 and the external electrode part 6 (E1) disposed on the bottom surface, and the penetrating portion 5 for electrically connecting the conductor portion 30 of the pattern layer n6 and the external electrode part 6 (E2) disposed on the bottom surface. The laminated group G7 may include the first sheet A. The conductor portion 30 of the laminated group G7 (particularly, the pattern layer n11) constitutes about one turn of the first coil.

The laminated group G8 includes the pattern layers n12 and n13, these pattern layers being integrated in advance prior to lamination with other laminated groups. The pattern layer n12 is similar to the pattern layer n10 of the laminated group G7. The pattern layer n13 is similar to the pattern layer n11 of the laminated group G7 except that the pattern shapes of the conductor portions 30 constituting the second coils (32) are different from each other. The laminated group G8 may include the first sheet A. The conductor portion 30 of the laminated group G8 (particularly, the pattern layer n13) constitutes about ½ turns of the second coil.

The laminated group G9 includes only the pattern layer n14. The pattern layer n14 is similar to the pattern layer n7 of the laminated group G5 except that it further includes the penetrating portion 5 for electrically connecting the conductor portion 30 of the pattern layer n9 and the external electrode part 6 (E3) disposed on the bottom surface, and the penetrating portion 5 for electrically connecting the conductor portion 30 of the pattern layer n13 and the external electrode part 6 (E4) disposed on the bottom surface. The laminated group G9 may include the first sheet B described above.

The laminated group G10 includes only the pattern layer n15. The pattern layer n15 includes, in the magnetic portion 20 (or magnetic sheet), the penetrating portion 5 for electrically connecting the conductor portion 30 of the pattern layer n2 and the external electrode part 6 (E1) disposed on the bottom surface, the penetrating portion 5 for electrically connecting the conductor portion 30 of the pattern layer n6 and the external electrode part 6 (E2) disposed on the bottom surface, the penetrating portion 5 for electrically connecting the conductor portion 30 of the pattern layer n9 and the external electrode part 6 (E3) disposed on the bottom surface, and the penetrating portion 5 for electrically connecting the conductor portion 30 of the pattern layer n13 and the external electrode part 6 (E4) disposed on the bottom surface. The laminated group G10 may include the second sheet described above.

The laminated group G11 includes only the pattern layer n16. The pattern layer n16 is similar to the pattern layer n15 of the laminated group G10. The laminated group G11 may include the second sheet described above.

The laminated group G12 includes only the pattern layer n17. The pattern layer n17 includes, in the magnetic portion 20 (or magnetic sheet), the external electrode part 6 (E1) electrically connected to the conductor portion 30 of the pattern layer n2, the external electrode part 6 (E2) electrically connected to the conductor portion 30 of the pattern layer n6, the external electrode part 6 (E3) electrically connected to the conductor portion 30 of the pattern layer n9, and the external electrode part 6 (E4) electrically connected to the conductor portion 30 of the pattern layer n13. Each of the external electrode parts 6 (E1 to E4) is disposed near a corner of the bottom surface in plan view of the magnetic portion 20 (or the magnetic sheet). The laminated group G12 may include the first sheet C described above.

The method for manufacturing a laminated inductor according to the present disclosure is characterized by laminating a plurality of the first sheets A.

For example, the first sheet A as the laminated group G3 and the first sheet A as the laminated group G4 are laminated as illustrated in FIGS. 2 and 3. By laminating such two first sheets A, a first coil layer including the first coil (31 in FIG. 1), in which the conductor portion 30 of the laminated group G3 and the conductor portion 30 of the laminated group G4 are electrically connected with the via part 4 (first via portion) interposed therebetween, is formed.

In addition, the first sheet A as the laminated group G6, the first sheet A as the laminated group G7, and the first sheet A as the laminated group G8, for example, are laminated as illustrated in FIGS. 2 and 3. By laminating such three first sheets A, a second coil layer including the second coil (32 in FIG. 1), in which the conductor portion 30 of the laminated group G6, the conductor portion 30 of the laminated group G7, and the conductor portion 30 of the laminated group G8 are electrically connected with the via part 4 (first via portion) interposed therebetween, is formed.

In the present disclosure, a plurality of the first sheet A, corresponding to two sheets in the conventional method, are laminated, so that the number of laminated layers during manufacturing can be further reduced. In addition, the first sheet A is manufactured without penetrating the substrate as described above, so that the magnetic sheet 200 can be formed as a thinner magnetic layer. Therefore, the first sheet A is useful for adjusting the thickness of the base body (particularly, each pattern layer constituting the base body). Furthermore, the first sheet A can be manufactured by using only one substrate for one sheet, so that the first sheet A is excellent in manufacturing cost. Furthermore, by using the first sheet A, the via part can be formed more thinly and the conductor portion can be formed more thickly with a limited base body size, so that the characteristics of the inductor can be improved.

In the present disclosure, it is preferable to further laminate one or more second sheets on the lower side of the first coil layer to form a through-conductor layer. As a result, the through-conductor layer can have a penetrating portion penetrating the one or more second sheets, and the penetrating portion is electrically connected to both ends of the first coil of at least the first coil layer. Since the second sheet is manufactured by penetrating the substrate as described above, the magnetic sheet 200 can be formed as a thicker magnetic layer. Therefore, the second sheet is further useful for forming the penetrating portion, and is capable of further reducing the number of laminated layers during manufacturing.

In detail, the second sheet as the laminated group G10 and the second sheet as the laminated group G11 are further laminated on the lower side of the coil layer, as illustrated in FIGS. 2 and 3.

For example, when the laminated inductor has only one coil layer, the one or more second sheets are laminated on the lower side of the coil layer to form the through-conductor layer. At this time, the number of the penetrating portions penetrating the one or more second sheets in the through-conductor layer is usually two. Such two penetrating portions are electrically connected to both ends of the first coil of the first coil layer. In detail, one of the two penetrating portions is electrically connected to one end of the first coil, and the other penetrating portion is electrically connected to the other end of the first coil. As a result, electrical connection between both ends of the first coil and the external electrode parts on the bottom surface of the base body is achieved.

In addition, when the laminated inductor includes, for example, two coil layers (i.e., the first coil layer and the second coil layer) as illustrated in FIGS. 2 and 3, the one or more second sheets are laminated on the lower side of the coil layer disposed at the lowest level (second coil layer in FIGS. 2 and 3) of the two or more coil layers, thereby enabling the through-conductor layer to be formed. At this time, the number of the penetrating portions penetrating the one or more second sheets in the through-conductor layer is usually four. Such four penetrating portions are electrically connected to both ends (C1s, C1e) of the first coil of the first coil layer and both ends (C2s, C2c) of the second coil of the second coil layer. In detail, each of both ends (C1s, C1e) of the first coil and both ends (C2s, C2c) of the second coil are electrically connected to the external electrode parts 6 (E1, E2, E3, E4) with one penetrating portion of the four penetrating portions interposed therebetween.

In the present disclosure, it is preferable to further laminate the first sheet C on the lower side of the through-conductor layer to form an external electrode part layer. As a result, the external electrode part 6 is electrically connected to the penetrating portion of the through-conductor layer with the third via portion interposed therebetween. The number of the first sheets C laminated is usually one. Since the first sheet C corresponds to two sheets in the conventional method, the number of laminated layers during manufacturing can be further reduced. In addition, by using the first sheet C, the external electrode part can be formed thinly with a limited base body size, so that the characteristics of the inductor can be improved. Furthermore, the first sheet C can be manufactured by using only one substrate for one sheet as shown in a manufacturing method to be described later, so that the first sheet C is also excellent in manufacturing cost, similarly to the first sheet A.

In detail, the first sheet C as the laminated group G12 is further laminated on the lower side of the through-conductor layer, as illustrated in FIGS. 2 and 3.

For example, when the laminated inductor has only one coil layer, a sheet 1c, having two external electrode parts, is usually laminated on the lower side of the penetrating portion for one sheet, thereby forming the external electrode part layer. At this time, the two external electrode parts are electrically connected to both ends of the first coil of the first coil layer. In detail, one of the two external electrode parts is electrically connected to one end of the first coil, and the other external electrode part is electrically connected to the other end of the first coil. As a result, electrical connection between both ends of the first coil and the external electrode parts is achieved.

In addition, when the laminated inductor includes, for example, two coil layers (i.e., the first coil layer and the second coil layer) as illustrated in FIGS. 2 and 3, the first sheet C, having four external electrode parts, is laminated on the lower side of the penetrating portion usually for one sheet, thereby forming the external electrode part layer. At this time, each of the four external electrode parts 6 (E1, E2, E3, E4) is electrically connected to both ends (C1s, C1e) of the first coil of the first coil layer and both ends (C2s, C2c) of the second coil of the second coil layer with one of the four penetrating portions interposed therebetween.

In the present disclosure, it is preferable to form an inter-coil layer and the second coil layer formed between the first coil layer and the through-conductor layer, as illustrated in FIGS. 2 and 3. As a result, a 2-in-1 inductor is obtained, and the characteristics of the inductor can be further improved with a limited base body size.

In detail, the second coil layer is formed to include the second coil to which the conductor portion is electrically connected with the first via portion in a plurality of the first sheets A interposed therebetween, by further laminating the plurality of the first sheets A selected from a range similar to that of the first sheet A forming the first coil layer.

For example, as illustrated in FIGS. 1 to 3, the second coil layer is formed to include the second coil (32 in FIG. 1) to which the conductor portion 30 is electrically connected with the via part 4 (first via portion) in three first sheets A, by laminating three first sheets A as the laminated groups G6 to G8.

Usually, the second coil layer includes further one or more first sheets B laminated on the lower side of (or directly under) a laminated body of the further plurality of the first sheets A, as illustrated in FIGS. 1 to 3. The second coil of the second coil layer and the penetrating portion of the through-conductor layer are electrically connected with the via part 4 (second via portion) (or the penetrating portion 5) of the further one or more first sheets B.

The inter-coil layer is formed by laminating one or more (preferably one) first sheets B on the lower side of (or directly under) the first coil layer (particularly, between the first coil layer and the second coil layer). Electrical connection between both ends of the first coil of the first coil layer and the external electrode part on the bottom surface of the base body is achieved with the penetrating portion of the inter-coil layer interposed therebetween. By forming the inter-coil layer, insulation between the first coil and the second coil can be sufficiently ensured.

For example, as illustrated in FIGS. 1 to 3, the inter-coil layer is formed by laminating one or more (preferably one) first sheets B as the laminated group G5 on the lower side of (or directly under) the first coil layer (particularly, between the first coil layer and the second coil layer).

In the laminated inductor of the present disclosure, a thickness M (see FIG. 3) of the inter-coil layer is preferably larger than a distance L1 between the conductor portions 30 of the first coil in the first coil layer and a distance L2 between the conductor portions of the second coil in the second coil layer. By satisfying such a relationship, the insulation between the first coil and the second coil can be further sufficiently ensured.

The thickness M of the inter-coil layer refers to an inter-coil distance, and in detail, is a distance between the lowermost conductor portion 30 among the conductor portions 30 of the coil (e.g., the first coil) disposed at higher levels than the inter-coil layer and the uppermost conductor portion 30 among the conductor portions 30 of the coil (e.g., the second coil) disposed at lower levels than the inter-coil layer. As the thickness M of the inter-coil layer, an average value of the thicknesses M of the inter-coil layer at arbitrary 10 positions in section view is used. The thickness M is not particularly limited, and for example, may be 20 μm or more and 60 μm or less (i.e., from 20 μm to 60 μm), and particularly 30 μm or more and 40 μm or less (i.e., from 30 μm to 40 μm).

As the distance L1 between the conductor portions 30 of the first coil, an average value of the distances L1 at arbitrary 10 positions in section view is used. The distance L1 is not particularly limited, and for example, may be 10 μm or more and 40 μm or less (i.e., from 10 μm to 40 μm), and particularly 15 μm or more and 25 μm or less (i.e., from 15 μm to 25 μm).

As the distance L2 between the conductor portions 30 of the second coil, an average value of the distances L2 at arbitrary 10 positions in section view is used. The distance L2 is not particularly limited, and for example, may be a value within a range similar to that of the distance L1 between the conductor portions 30 of the first coil described above.

After an unfired base body precursor is obtained by laminating desired laminated groups, the unfired base body precursor is usually subjected to a pressure treatment to obtain a laminated body. The method for the pressure treatment is not particularly limited, and for example, may be a press processing method such as warm isostatic press (WIP). After the pressure treatment, the laminated body is usually placed in a firing furnace, subjected to a degreasing treatment, and then subjected to firing in the atmosphere. The firing temperature is not particularly limited, and is, for example, 600° C. or higher and 800° C. or lower (i.e., from 600° C. to 800° C.). The firing time is not particularly limited, and is, for example, 30 minutes or more and 300 minutes or less (i.e., from 30 minutes to 300 minutes).

After the base body is obtained by firing, an exterior resin layer may be formed on the surface of the base body. The exterior resin layer may be usually formed in an area other than the surface of the external electrode part on the bottom surface of the base body surface. The material constituting the exterior resin layer is not particularly limited as long as it protects the base body, and may be any known polymer.

The technical scope of the present disclosure is not to be construed only by the above-described embodiments, but is defined based on the description of the claims. In addition, the technical scope of the present disclosure encompasses meanings equivalent to the claims and all modifications within the scope.

The laminated inductor and the method for manufacturing the same according to the present disclosure include the following aspects.

<1> A method for manufacturing a laminated inductor, the method including preparing a plurality of first sheets A each having a conductor portion and a magnetic portion formed on a lower side of a magnetic sheet, and a first via portion penetrating the magnetic sheet on an upper side of the conductor portion; and laminating the plurality of first sheets A to form a first coil layer including a first coil to which the conductor portion is electrically connected with the first via portion interposed therebetween.

<2> The method for manufacturing a laminated inductor according to <1>, in which, in each of the first sheets A, a diameter D1 of the first via portion is smaller than a width D2 of the conductor portion.

<3> The method for manufacturing a laminated inductor according to <1> or <2>, in which, in each of the first sheets A, a thickness T1 of the first via portion is smaller than a thickness T2 of the conductor portion.

<4> The method for manufacturing a laminated inductor according to any one of <1> to <3>, in which, in each of the first sheets A, the first via portion has a tapered shape whose upper width is smaller than its lower width in section view.

<5> The method for manufacturing a laminated inductor according to any one of <1> to <4>, in which a second sheet having a penetrating portion is further prepared, a through-conductor layer is formed by further laminating one or more of the second sheets on a lower side of the first coil layer, and the penetrating portion is electrically connected to both ends of the first coil.

<6> The method for manufacturing a laminated inductor according to <5>, in which a thickness T7 of the penetrating portion in each of the second sheets is larger than the thickness T1 of the first via portion in the first sheet A.

<7> The method for manufacturing a laminated inductor according to <5> or <6>, in which an inter-coil layer and a second coil layer are formed between the first coil layer and the through-conductor layer, the second coil layer is formed to include a second coil to which the conductor portion is electrically connected with the first via portion interposed therebetween, by laminating a further plurality of first sheets A, a first sheet B, including a second via portion penetrating a magnetic sheet and including a flange-shaped conductor portion formed around the second via portion on the lower side of the magnetic sheet and a magnetic portion formed further around the flange-shaped conductor portion, is prepared, and the inter-coil layer is formed by laminating one or more of the first sheets B.

<8> The method for manufacturing a laminated inductor according to <7>, in which a thickness M of the inter-coil layer is larger than a distance L1 between the conductor portions of the first coil and a distance L2 between the conductor portions of the second coil.

<9> The method for manufacturing a laminated inductor according to <7> or <8>, in which, in each of the first sheets B, a diameter D3 of the second via portion is smaller than a width D40 of the flange-shaped conductor portion.

<10> The method for manufacturing a laminated inductor according to any one of <7> to <9>, in which an external electrode part layer is formed by further laminating a first sheet C on a lower side of the through-conductor layer, the first sheet C includes an external electrode part and a magnetic portion formed on the lower side of the magnetic sheet, and a third via portion penetrating the magnetic sheet on an upper side of the external electrode part, and the external electrode part is electrically connected to the penetrating portion with the third via portion interposed therebetween.

<11> The method for manufacturing a laminated inductor according to <10>, in which the third via portion has a tapered shape whose upper width is smaller than its lower width in section view.

The present disclosure can be used in a method for manufacturing a laminated inductor in which the number of laminated layers is reduced.

What is claimed is:

1. A method for manufacturing a laminated inductor, the method comprising:
preparing a plurality of first sheets A each having a conductor portion and a magnetic portion on a lower side of a magnetic sheet, and a first via portion penetrating the magnetic sheet on an upper side of the conductor portion; and
laminating the plurality of first sheets A to configure a first coil layer including a first coil in which the conductor portions are electrically connected with the first via portion interposed therebetween.

2. The method for manufacturing a laminated inductor according to claim 1, wherein
in each of the first sheets A, a diameter D1 of the first via portion is smaller than a width D2 of the conductor portion.

3. The method for manufacturing a laminated inductor according to claim 1, wherein
in each of the first sheets A, a thickness T1 of the first via portion is smaller than a thickness T2 of the conductor portion.

4. The method for manufacturing a laminated inductor according to claim 1, wherein
in each of the first sheets A, the first via portion has a tapered shape whose upper width is smaller than its lower width in a cross-sectional view.

5. The method for manufacturing a laminated inductor according to claim 1, further comprising:
preparing a second sheet having a penetrating portion, and
forming a through-conductor layer by further laminating one or more of the second sheets on a lower side of the first coil layer and connecting a plurality of the penetrating portions, and
wherein the penetrating portions are electrically connected to both ends of the first coil.

6. The method for manufacturing a laminated inductor according to claim 5, wherein
a thickness T7 of the penetrating portion in each of the second sheets is larger than the thickness T1 of the first via portion in the first sheet A.

7. The method for manufacturing a laminated inductor according to claim 5, further comprising:
forming an inter-coil layer and a second coil layer which are between the first coil layer and the through-conductor layer,
the second coil layer including a second coil to which the conductor portions are electrically connected with the first via portion interposed therebetween, by laminating a further plurality of first sheets A,
preparing a first sheet B, including a second via portion penetrating a magnetic sheet, a flange-shaped conductor portion around the second via portion on the lower side of the magnetic sheet, and a magnetic portion further around the flange-shaped conductor portion, and
wherein the inter-coil layer is formed by laminating one or more of the first sheets B.

8. The method for manufacturing a laminated inductor according to claim 7, wherein
a thickness M of the inter-coil layer is larger than a distance L1 between the conductor portions of the first coil and a distance L2 between the conductor portions of the second coil.

9. The method for manufacturing a laminated inductor according to claim 7, wherein
in each of the first sheets B, a diameter D3 of the second via portion is smaller than a width D40 of the flange-shaped conductor portion.

10. The method for manufacturing a laminated inductor according to claim 7, further comprising:
forming an external electrode part layer by further laminating a first sheet Con a lower side of the through-conductor layer,
wherein
the first sheet C includes an external electrode part and a magnetic portion formed on the lower side of the magnetic sheet, and a third via portion penetrating the magnetic sheet on an upper side of the external electrode part, and
the external electrode part is electrically connected to the penetrating portion via the third via portion.

11. The method for manufacturing a laminated inductor according to claim 10, wherein
the third via portion has a tapered shape whose upper width is smaller than its lower width in a cross-sectional view.
